(19) United States
(12) Patent Application Publication
(10) Pub. No.: US 2008/0200139 A1
(43) Pub. Date: Aug. 21, 2008

(54) Gain adjusting apparatus, storage apparatus, and gain adjusting method

(75) Inventor: Manabu Kobayashi, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/998,967

(22) Filed: Dec. 3, 2007

(30) Foreign Application Priority Data
Feb. 20, 2007 (JP) 2007-039930

(51) Int. Cl. H04B 1/06

(52) U.S. Cl. 455/232.1

(57) ABSTRACT

A total gain candidate determining unit determines candidates suitable as a total gain Kt in an AGC feedback loop including an equalizer, an A/D converter, and an FIR filter. For each candidate for the total gain Kt, a gain setting unit sets a corresponding gain Kp in a preamplifier 10, and sequentially sets, in the A/D converter and the FIR filter, a gain Ka and a gain Kf which satisfy the total gain Kt. A written data storage unit stores known written data. An error rate calculating unit calculates an error rate of read data by comparing the read data and the written data. An second determining unit determines, as an optimal combination of gains, a combination of gains in which the error rate is the least.

### BACKGROUND OF THE INVENTION

1. Field of the Invention

The present invention relates to gain adjusting apparatuses, storage apparatuses, and gain adjusting methods for adjusting gains in a feedback loop that performs automatic gain control (AGC) of a variable gain amplifier. In particular, the present invention relates to a gain adjusting apparatus, a storage apparatus, and a gain adjusting method that allow AGC to operate normally, while suppressing an error rate to the minimum.

2. Description of the Related Art

Hitherto, in a storage apparatus such as a magnetic disk apparatus, when data is read from a magnetic disk as a storage medium, AGC may be performed on a reproduction signal read by a head (see, for example, Japanese Unexamined Patent Application Publication No. 11-185386). In AGC, by controlling a gain of an amplifier for amplifying the reproduction signal, the amplitude of an amplified signal is maintained to be constant.

FIG. 1 is a block diagram showing an example of the configuration of an AGC circuit provided in a magnetic disk apparatus. The AGC circuit shown in FIG. 1 includes a preamplifier 10, a variable gain amplifier 20, an equalizer 30, an A/D (analog-to-digital) converter 40, an FIR (finite impulse response) filter unit 50, an AGC unit 60, and a maximum likelihood decoding unit 70.

The preamplifier 10 amplifies a reproduction signal read by a head (not shown) from a magnetic disk at a preset gain Kp. At this time, the AGC circuit needs to amplify the amplitude of the reproduction signal to a target amplitude. Thus, the preamplifier 10 amplifies the amplitude of the reproduction signal up to a range in which AGC can perform amplification to the target amplitude. In other words, the gain Kp of the preamplifier 10 is a gain for amplifying the reproduction signal up to a range in which AGC by the variable gain amplifier 20 is possible.

The variable gain amplifier 20 amplifies the preamplified signal at a variable gain Kv. As described later, the gain Kv of the variable gain amplifier 20 is set under the control of the AGC unit 60 in order to match the amplitude of an amplified signal with a target amplitude.

The equalizer 30 adjusts characteristics of the amplified signal for each frequency. The A/D converter 40 amplifies a signal output from the equalizer 30 at a preset gain Ka, quantizes the amplified signal, and converts the quantized signal from an analog form into a digital form. By performing filtering on a digital signal output from the A/D converter 40, the FIR filter 50 outputs a signal obtained by PR (partial response) equalization. At this time, the signal is shaped also by the filtering of the FIR filter 50, and the signal is amplified at a preset gain Kf.

The AGC unit 60 compares the amplitude of the signal output from the FIR filter 50 with a target amplitude, and controls a gain Kv of the variable gain amplifier 20 in accordance with the result of the comparison. In other words, when the amplitude of the signal output from the FIR filter 50 is less than the target amplitude, the AGC unit 60 increases the gain Kv of the variable gain amplifier 20, whereby the amplitude of the signal output from the FIR filter 50 is larger than the target amplitude. Conversely, when the amplitude of the signal output from the FIR filter 50 is larger than the target amplitude, the AGC unit 60 reduces the gain Kv of the variable gain amplifier 20, whereby the amplitude of the signal output from the FIR filter 50 is less than the target amplitude.

The maximum likelihood decoding unit 70 uses, for example, Viterbi detection or the like, to determine the most probable data series (the maximum likelihood data series) from the PR-equalized signal, and outputs binarized read data.

As described above, in the AGC circuit shown in FIG. 1, by forming a feedback loop that controls the gain Kv of the variable gain amplifier 20 in accordance with the amplitude of the signal output from the FIR filter 50, the amplitude of the signal output from the FIR filter 50 can be matched with the target amplitude. At this time, although the gain Kv of the variable gain amplifier 20 is controlled by the AGC unit 60, the gain Kp of the preamplifier 10, the gain Ka of the A/D converter 40, and the gain Kf of the FIR filter 50 are fixed as initially set. Therefore, it is necessary to set the gain Kp, the gain Ka, and the gain Kf so that amplification to the target amplitude can be performed in a variable range of the gain Kv of the variable gain amplifier 20.

However, the gains in the feedback loop of AGC, such as the gain Ka of the A/D converter 40 and the gain Kf of the FIR filter 50, are closely related to an error rate of read data. Accordingly, it is not preferable that the gains be set on the basis of only the variable range of the gain Kv of the variable gain amplifier 20.

Specifically, as shown in, for example, FIG. 2, the error rates increases if the gain Kf of the FIR filter 50 is too small or too large, so that error in read data increases. Regarding the gain Ka of the A/D converter 40, in the case of the gain Ka (indicated by the dotted line in FIG. 9) that is 0.8 times the optimal gain Ka (indicated by the solid line in FIG. 9), and the gain Ka (indicated by the alternate long and short dash line in FIG. 9) that is 0.6 times the optimal gain Ka, the error rate increases, so that error in read data increases.

The increase in error rate is caused by the following reason. That is, when the gain Kf of the FIR filter 50 is large, the amplitude of the signal output from the A/D converter 40 is small. Accordingly, the quantization in the A/D converter 40 is subject to the influence of minute error in amplitude. Therefore, an increase in gain Kf increases error in A/D conversion.

In addition, when the gain Kf of the FIR filter 50 is small, the amplitude of the signal output from the A/D converter 40 is large, and, similarly, the amplitude of the signal in the equalizer 30 is also large. When the amplitude of the signal in the equalizer 30 is large, the amplitude becomes saturated in frequency characteristic adjustment and a peak portion of the amplitude may be deformed, so that error in equalizing increases. This can be understood also from the fact that, in FIG. 9, a decrease in gain Ka increases the error rate.

As described above, when the gain Ka of the A/D converter 40 and the gain Kf of the FIR filter 50 are too large or too small, the error rate increases. Accordingly, each gain has an optimal value. However, in a case in which the gain Ka of the A/D converter 40 and the gain Kf of the FIR filter 50 are set to optimal values, even if the reproduction signal is amplified to the maximum at the gain Kp of the preamplifier 10, the amplitude of the preamplified signal cannot be amplified to the target amplitude within the variable range of the gain Kv of the variable gain amplifier 20, so that AGC may be impossible.

In particular, in storage apparatuses such as magnetic disk apparatuses, individual differences of heads for directly reading signals from recording media (e.g., magnetic disks) cause variations in reproduction signal amplitude. Accordingly, in a storage apparatus provided with a head in which a reproduction signal amplitude is too small, AGC does not operate normally.

### SUMMARY

The present invention has been made in view of the above-described points. It is an object of the present invention to provide a gain adjusting apparatus, a storage apparatus, and a gain adjusting method that allow AGC to operate normally, while suppressing an error rate to the minimum.

To solve the above-described problems, according to an aspect of the present invention, there is provided a gain adjusting apparatus for adjusting gains in a feedback loop for performing automatic gain control of a variable gain amplifier. The gain adjusting apparatus includes a first determining unit that determines a total gain in a plurality of processes in the feedback loop, in which an amplitude of an input signal can be matched with a predetermined target amplitude within a variable range of a gain of the variable gain amplifier, a gain setting unit that sequentially sets combinations of gains in the processes, the combinations equaling the total gain determined by the first determining unit, and an second determining unit that determines an optimal combination of gains in accordance with a status of a signal amplified at the gains set by the gain setting unit.

According to the gain adjusting apparatus, a total gain at which AGC is possible within a variable range of a gain of a variable gain amplifier is determined, combinations of gains, for processes, equaling the total gain are sequentially set in a feedback loop, and an optimal combination of gains is determined in accordance with a status of a signal amplified at set gains. Therefore, gains, for an AD converter, an FIR filter, etc., in the feedback loop, for minimizing error, can be selected, so that the AGC can operate normally, while suppressing an error rate to the minimum.

According to another aspect of the present invention, there is provided a storage apparatus for amplifying a reproduction signal of data stored in a storage medium by performing automatic gain control of a variable gain amplifier. The storage apparatus includes a first determining unit that determines a total gain in a plurality of processes in an automatic-gain-control feedback loop in which an amplitude of an input signal can be matched with a predetermined target amplitude within a variable range of a gain of the variable gain amplifier, a gain setting unit that sequentially sets combinations of gains in the processes, the combinations equaling the total gain determined by the first determining unit, and an second determining unit that determines an optimal combination of gains in accordance with a status of a signal amplified at the gains set by the gain setting unit.

According to the storage apparatus, a total gain at which AGC is possible within a variable range of a gain of a variable gain amplifier is determined, combinations of gains, for processes, equaling the total gain are sequentially set in a feedback loop, and an optimal combination of gains is determined in accordance with a status of a signal amplified at set gains. Therefore, gains, for an AD converter, an FIR filter, etc., in the feedback loop, for minimizing error, can be selected, so that the AGC can operate normally, while suppressing an error rate to the minimum.

According to another aspect of the present invention, there is provided a gain adjusting method for adjusting gains in a feedback loop for performing automatic gain control of a variable gain amplifier. The gain adjusting method includes the steps of determining a total gain in a plurality of processes in the feedback loop, in which an amplitude of an input signal can be matched with a predetermined target amplitude within a variable range of a gain of the variable gain amplifier, sequentially setting combinations of gains in the processes, the combinations equaling the total gain determined in the gain determining step, and determining an optimal combination of gains in accordance with a status of a signal amplified at the gains set in the setting step.

According to the gain adjusting method, a total gain at which AGC is possible within a variable range of a gain of a variable gain amplifier is determined, combinations of gains, for processes, equaling the total gain are sequentially set in a feedback loop, and an optimal combination of gains is determined in accordance with a status of a signal amplified at set gains. Therefore, gains, for an AD converter, an FIR filter, etc., in the feedback loop, for minimizing error, can be selected, so that the AGC can operate normally, while suppressing an error rate to the minimum.

### BRIEF DESCRIPTION OF THE DRAWINGS

FIG. 1 is a block diagram showing an example of the configuration of an AGC circuit according to the related art;

FIG. 2 is a graph showing an example of a relationship between a gain and error rate in the AGC circuit according to the related art;

FIG. 3 is a block diagram showing a main configuration of a gain adjusting apparatus according to a first embodiment of the present invention;

FIGS. 4A and 4B are a flowchart showing a gain adjusting operation in the first embodiment;

FIG. 5 is an illustration showing examples of error rates for combinations of gains in the first embodiment;

FIG. 6 is a block diagram showing a main configuration of a gain adjusting apparatus according to a second embodiment of the present invention;

FIGS. 7A and 7B are a flowchart showing a gain adjusting operation in the second embodiment;

FIGS. 8A and 8B are graphs showing examples of filtering by an equalizer; and

FIGS. 9A and 9B are graphs showing examples of quantization by an A/D converter;

### DESCRIPTION OF THE PREFERRED EMBODIMENTS

Embodiments of the present invention are fully described with reference to the accompanying drawings. In the following, AGC in a storage apparatus such as a magnetic disk apparatus is described as an example. However, the present invention can be applied also to AGC in, for example, a communication apparatus and an acoustic apparatus.

### First Embodiment

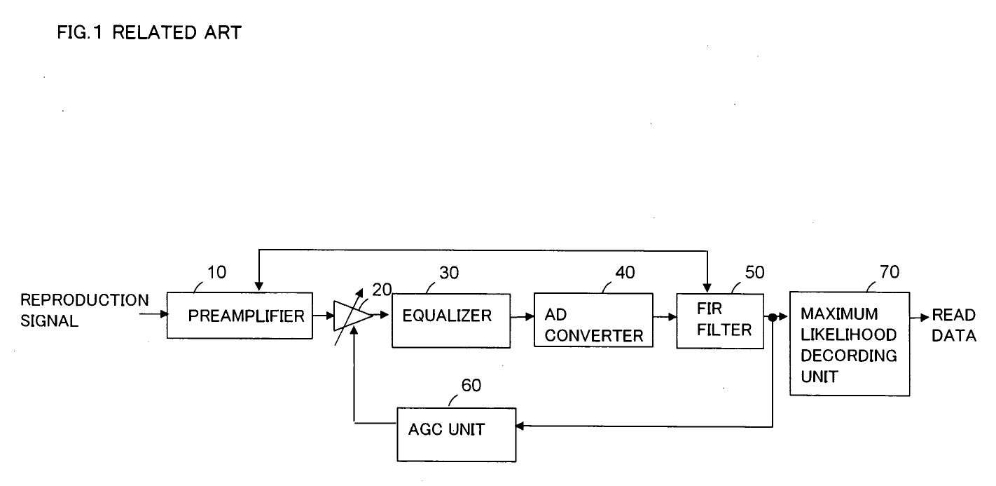

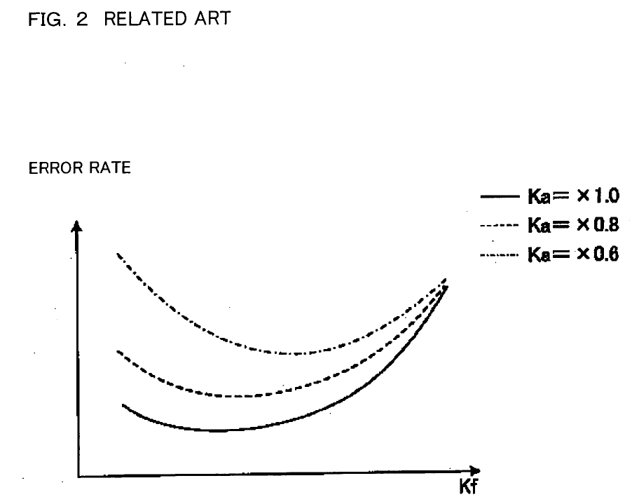

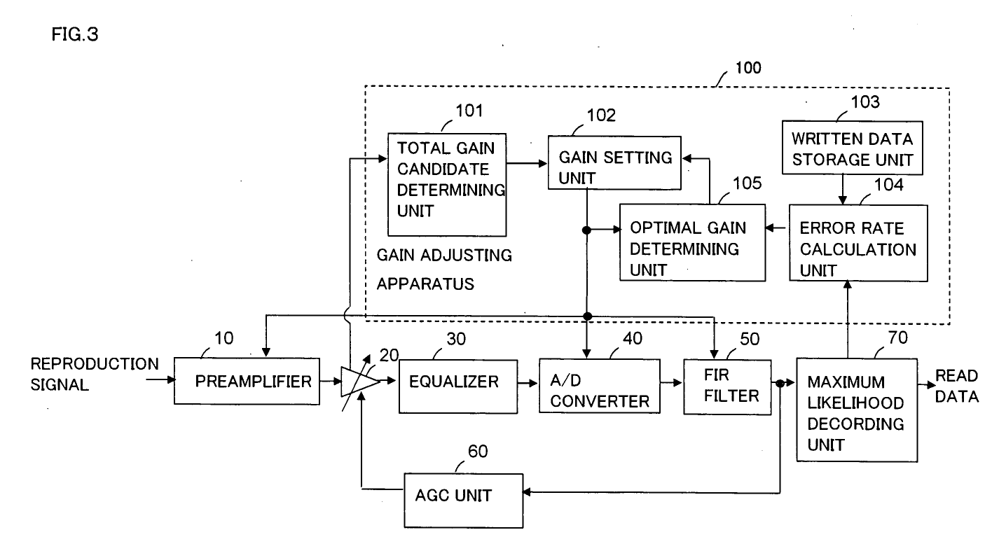

FIG. 3 is a block diagram showing a main configuration of a gain adjusting apparatus according to a first embodiment of the present invention. In FIG. 3, portions identical to those shown in FIG. 1 are denoted by identical reference numerals, and descriptions thereof are omitted. The gain adjusting apparatus 100 shown in FIG. 3 includes a total gain candidate determining unit 101 as a first determining unit, a gain setting unit 102, a written data storage unit 103, an error rate calculating unit 104, and an optimal gain determining unit 105 as a second determining unit.

The total gain candidate determining unit 101 determines candidates suitable as a total gain Kt in an AGC feedback loop including an equalizer 30, an A/D converter 40, and an FIR filter 50. In other words, the total gain candidate determining unit 101 regards the equalizer 30, the A/D converter 40, and the FIR filter 50 as a virtual amplifier, and detects a combination of gains in which AGC is possible on the basis of the gain (i.e., the total gain Kt) of the amplifier and a gain Kp of the preamplifier 10. The total gain candidate determining unit 101 stores, as a total gain candidate, the total gain Kt of the combination in which AGC is possible.

Specifically, the total gain candidate determining unit 101 grasps possible values of the total gain Kt which are calculated from possible values of a gain Ka of the A/D converter 40 and possible values of a gain Kf of the FIR filter 50. When the gain Kp of a preamplifier 10 is adjusted for each value of the total gain Kt of the A/D converter 40 and the FIR filter 50, the total gain candidate determining unit 101 determines whether a signal amplitude falls within an AGC control range by the variable gain amplifier 20. In other words, when the total gain Kt and the gain Kp of the preamplifier 10 are fixed, the total gain candidate determining unit 101 determines whether to match the signal amplitude with a target amplitude by changing the gain Kv of the variable gain amplifier 20. At this time, if the gain Kv of the variable gain amplifier 20 is an upper limit or lower limit of a variable range on the basis of AGC, the total gain candidate determining unit 101 determines that AGC is impossible in a variable range of the gain Kv.

For each candidate for the total gain Kt determined by the total gain candidate determining unit 101, the gain setting unit 102 sets a corresponding gain Kp in the preamplifier 10, and respectively sets the gain Ka and the gain Kf in the A/D converter 40 and the FIR filter 50, with the total gain Kt as a condition of constraint. At this time, the gain setting unit 102 sequentially sets, in the A/D converter 40 and the FIR filter 50, all combinations of the gain Ka and the gain Kf corresponding to all candidates for the total gain Kt. Whenever the setting is performed, the gain setting unit 102 reports the gain Kp, the gain Ka, and the gain Kf to the optimal gain determining unit 105.

In addition, when a combination of optimal gains is reported from the optimal gain determining unit 105, the gain setting unit 102 sets the gain Kp of the preamplifier 10, the gain Ka of the A/D converter 40, and the gain Kf of the FIR filter 50 to the reported values.

The written data storage unit 103 stores known written data that is written in a recording medium (not shown) such as a magnetic disk. Since the written data is stored in the written data storage unit 103, by reading and comparing the data, an error rate of read data can be calculated. In this embodiment, the written data storage unit 103 stores the written data that is written in the written data storage unit 103. However, if the error rate can be calculated on the basis of comparison with the read data, known data other than the written data may be stored.

By comparing read data obtained by the maximum likelihood decoding unit 70 and the written data stored in the written data storage unit 103, the error rate calculating unit 104 calculates an error rate in read data. At this time, whenever the gain setting unit 102 sets the gain Kp of the preamplifier 10, the gain Ka of the A/D converter 40, and the gain Kf of the FIR filter 50, the error rate calculating unit 104 calculates the error rate. The error rate calculating unit 104 reports the calculated error rate to the optimal gain determining unit 105.

When a combination of the gain Kp, the gain Ka, and the gain Kf is reported from the gain setting unit 102, the optimal gain determining unit 105 receives an error rate corresponding to the combination from the error rate calculating unit 104 and stores the received error rate. After the optimal gain determining unit 105 stores error rates corresponding to all combinations of the gains, the optimal gain determining unit 105 determines that a combination of the gains to which the least error rate correspond is an optimal combination of gains, and instructs the gain setting unit 102 to respectively set the gain Kp, the gain Ka, and the gain Kf in this combination in the preamplifier 10, the A/D converter 40, and the FIR filter 50.

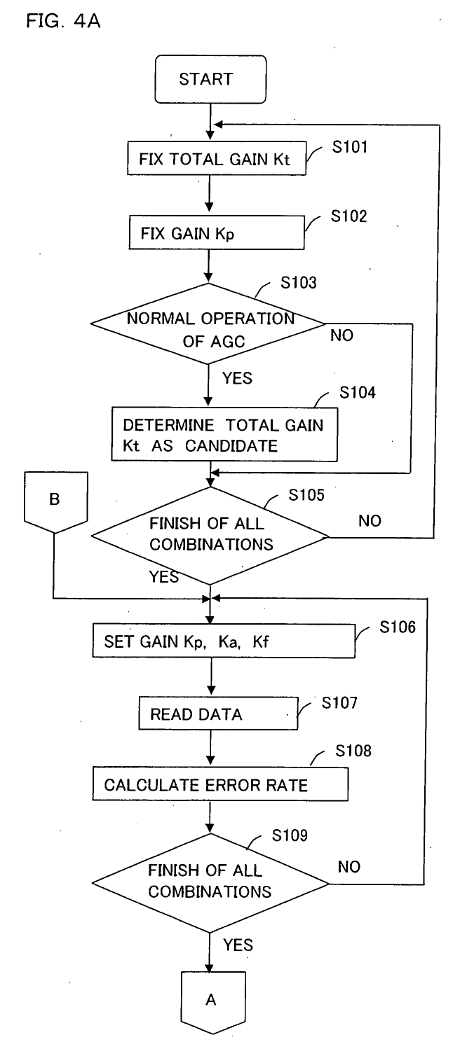

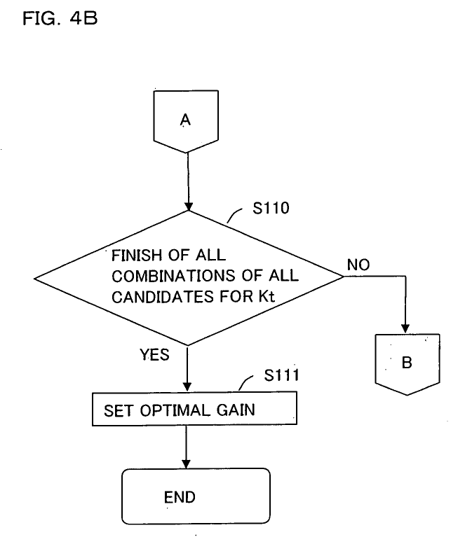

Next, a gain adjusting operation by the gain adjusting apparatus 100 having the above-described configuration is described with reference to the flowchart shown in FIGS. 4A and 4B. The gain adjusting operation in this embodiment broadly includes two processes, determination of candidates for the total gain Kt, and determination of the gain Kp, the gain Ka, and the gain Kf. In addition, in the following, it is assumed that known data is written in the recording medium (not shown) such as a magnetic disk, and it is assumed that the written data is stored in the written data storage unit 103.

First, in step S101, the total gain candidate determining unit 101 fixes the total gain Kt of an AGC feedback loop including the equalizer 30, the A/D converter 40, and the FIR filter 50. In other words, from values of the total gain Kt calculated from possible values of the gain Ka and the gain Kf, one value of the total gain Kt is selected and fixed by the total gain candidate determining unit 101. In step S102, the total gain candidate determining unit 101 fixes the gain Kp of the preamplifier 10 to one of possible values of the gain Kp.

In step S103, when the reproduction signal is preamplified at the gain Kp of the preamplifier 10, and is amplified at the total gain Kt, the total gain candidate determining unit 101 determines whether the amplitude of the reproduction signal can be matched with a target amplitude within a variable range of the gain Kv of the variable gain amplifier 20. In other words, when the total gain candidate determining unit 101 fixes the total gain Kt and the gain Kp, it is determined whether or not the AGC operates normally without fixation of the gain Kv of the variable gain amplifier 20 to an upper or lower limit of the variable range.

If it is determined that the AGC is possible (Yes in step S103), in step S104, the total gain candidate determining unit 101 determines and stores the fixed total gain Kt as a candidate for actual use. Simultaneously, the total gain candidate determining unit 101 also stores the gain Kp of the preamplifier 10 that is fixed so as to correspond to the candidate for the total gain Kt. Alternatively, if the AGC is impossible (No in step S103), the fixed total gain Kt and gain Kt are not stored in the total gain candidate determining unit 101.

In step S105, the total gain candidate determining unit 101 determines whether or not the above determination of whether the AGC is possible has finished for all combinations of possible values of the total gain Kt and the gain Kp. If the above determination of whether the AGC is possible has not finished yet (No in step S105), the total gain candidate determining unit 101 fixes the total gain Kt and the gain Kp for which the determination has not finished yet, and determines whether or not AGC is possible. If the above determination of whether the AGC is possible has finished for all the combinations (Yes in step S105), the total gain candidate determining unit 101 stores a combination of the total gain Kt and the gain Kp at which the amplitude of the reproduction signal can be matched with the target amplitude within the variable range of the gain Kv of the variable gain amplifier 20. This completes the determination of the candidate for the total gain Kt.

After completing the determination of the candidate for the total gain Kt, determination of the gain Kp, the gain Ka, and the gain Kf is performed. Specifically, one of the candidates for the total gain Kt stored in the total gain candidate determining unit 101 is selected, and the candidate for the total gain Kt and a corresponding gain Kp are reported to the gain setting unit 102. In step S106, the gain setting unit 102 determines the gain Ka of the A/D converter 40 and the gain Kf of the FIR filter 50 which satisfy the reported candidate for the total gain Kt, and respectively sets the gain Kp, the gain Ka, and the gain Kf in the preamplifier 10, the A/D converter 40, and the FIR filter 50. These gains are reported to the optimal gain determining unit 105.

After the gains are set, in step S107, data that is identical to the written data stored in the written data storage unit 103 is read from the recording medium (riot shown). In other words, a signal is read from the recording medium by a head (not shown), and is input as a reproduction signal to the preamplifier 10. The reproduction signal is preamplified at the gain Kp by the preamplifier 10 and is amplified at the gain Kv by the variable gain amplifier 20. The amplified signal is processed by each of the equalizer 30, the A/D converter 40, and the FIR filter 50. At this time, the gain Kv of the variable gain amplifier 20 is controlled by the AGC unit 60, whereby the amplitude of the reproduction signal is finally matched with the target amplitude. The combination of the total gain Kt and the gain Kp is determined in a range in which AGC is possible. Thus, it is ensured that the amplitude can be matched with the target amplitude within the variable range of the gain Kv of the variable gain amplifier 20.

The signal whose amplitude is matched with the target amplitude is input to the maximum likelihood decoding unit 70, and read data binarized by Viterbi detection is output to the error rate calculating unit 104. In step S108, the error rate calculating unit 104 calculates an error rate of the read data by comparing the read data and the written data stored in the written data storage unit 103. Here, if the read data is completely identical to the written data, the read data does not have any error at all, so that the error rate is the least.

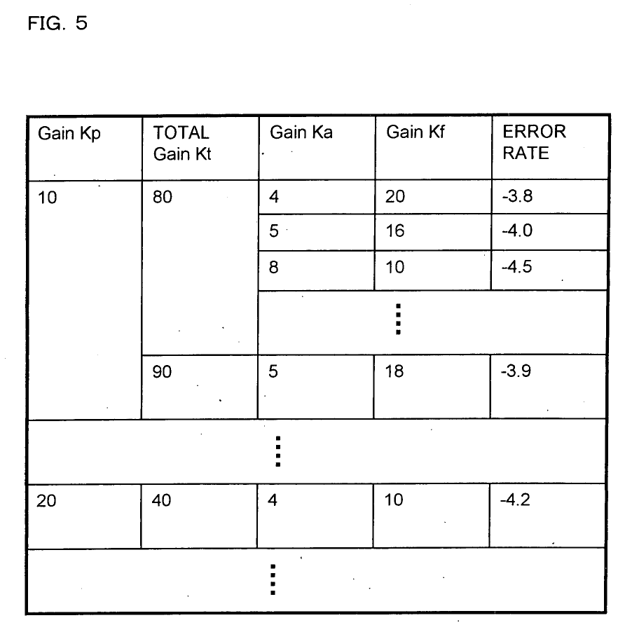

The calculated error rate is reported to the optimal gain determining unit 105. The error rate is stored by the optimal gain determining unit 105, with the error rate associated with a combination of currently set gains. Specifically, as shown in FIG. 5, combinations of gains reported from the gain setting unit 102 are stored in tabular form in the optimal gain determining unit 105. When the error rate is reported from the error rate calculating unit 104, the error rate is stored in the optimal gain determining unit 105, with the error rate associated with a combination of gains.

In step S109, after the gain Ka and the gain Kf are set with a candidate for the total gain Kt as a condition of constraint, the gain setting unit 102 determines whether or not the setting has finished for all combinations of the gain Ka and the gain Kf which satisfy the candidate for the total gain Kt. If the determination indicates that there is a combination of the gain Ka and the gain Kf which satisfy the candidate for the total gain Kt other than the already set combinations of the gain Ka and the gain Kf (No in step S109), the gain setting unit 102 sets, in the A/D converter 40 and the FIR filter 50, the combination of gains that has not been set. Reading of data and calculation of the error rate are performed again, and the optimal gain determining unit 105 stores an error rate corresponding to a new combination of gains.

If this processing is repeated and error rates are stored for all the combinations of the gain Ka and the gain Kf which satisfy the candidates for the total gain Kt (Yes in step S109), in step S110, the gain setting unit 102 determines whether or not the above processing has been performed for all the candidates for the total gain Kt. If this determination indicates that there is a candidate for the total gain Kt on which the above processing has not been performed yet (No in step S110), after the combination of the candidate for the total gain Kt and the gain Kp of the preamplifier 10 is altered, an error rate corresponding to a combination of the gain Ka and the gain Kf which satisfy the candidate for the total gain Kt is calculated. If error rate calculation has finished for all the combinations of the gain Ka and the gain Kf which satisfy all the candidates for the total gain Kt (Yes in step S110), the optimal gain determining unit 105 stores a list of correspondence between combinations of gains and error rates as shown in, for example, FIG. 5.

After the list of correspondence is completed, the optimal gain determining unit 105 determines that a combination of gain to which the least error rate corresponds is an optimal combination of gains, and reports the combination to the gain setting unit 102. For example, in FIG. 5, if the value “−4.5” in the bold frame is the least among all error rates, a combination of gains corresponding to this error rate is an optimal combination of gains. Therefore, the optimal gain determining unit 105 determines that a combination of “10” as the gain Kp of the preamplifier 10, “8” as the gain Ka of the A/D converter 40, and “10” as the gain Kf of the FIR filter 50 is optimal, and reports the combination to the gain setting unit 102. In step S111, when the combination is reported, the gain setting unit 102 respectively sets optimal gains in the preamplifier 10, the A/D converter 40, and the FIR filter 50.

It is confirmed that the gains, set in the preamplifier 10, the A/D converter 40, and the FIR filter 50, as described above, enable AGC within the variable range of the gain Kv of the variable gain amplifier 20 by candidate determination for the total gain Kt, and the set gains minimize the error rate of the read data. Since the gain Ka and the gain Kf are determined by calculating an actual error rate, these gains are optimal on the basis of considering characteristics of the head (not shown). Even if a plurality of heads have individual differences, gains adapted for each head are set.

As described above, according to the first embodiment, the entirety of an AGC feedback loop is regarded as a virtual amplifier, and, among combinations of a total gain that is a gain of the amplifier and a preamplifier gain, a combination that enables AGC using a variable gain amplifier 20 is determined. By using, as a condition of constraint, a total gain of the determined combination, gains in processing units of the AGC feedback loop are set, and gains at which the best error rate is obtained are selected. Accordingly, gains of the A/D converter 40, the FIR filter 50, etc., in a feedback loop that minimizes an error rate at a total gain at which AGC is possible are selected, whereby AGC can operate normally, while suppressing the error rate to the minimum.

In the first embodiment, the error rate is calculated by comparing the written data stored in the written data storage unit 103 with the read data. However, by using another error rate index such as a Viterbi metric margin (VMM) obtained in Viterbi detection, an optimal combination of gains may be selected.

### Second Embodiment

A second embodiment of the present invention has a feature in that, by detecting signal peaks in an equalizer and an A/D converter without calculating an error rate, an optimal combination of gains is selected on the basis of the magnitude of the detected signal peaks.

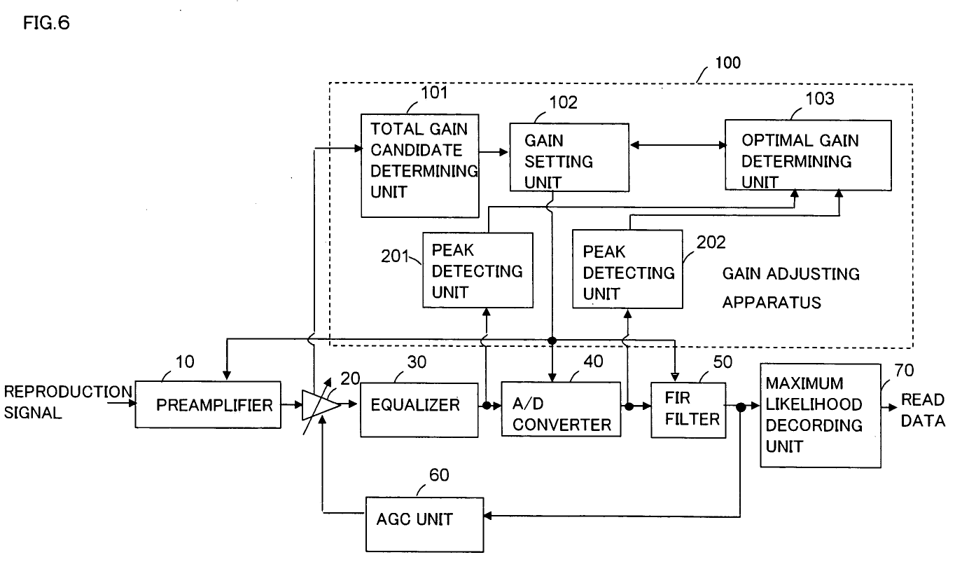

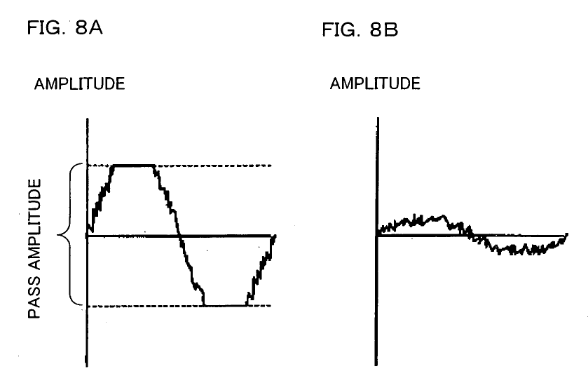

FIG. 6 is a block diagram showing a main configuration of a gain adjusting apparatus according to the second embodiment. In FIG. 6, portions identical to those shown in FIGS. 1 and 8 are denoted by identical reference numerals, and descriptions thereof are omitted. The gain adjusting apparatus 100 shown in FIG. 6 includes a total gain candidate determining unit 101, a gain setting unit 102, peak detecting units 201 and 202, and an optimal gain determining unit 203.

The peak detecting unit 201 detects a peak of the amplitude of a signal output from an equalizer 30. The equalizer 30 performs frequency characteristic adjustment, and a particular amplitude band is filtered to pass through the equalizer 30. Thus, the peak of the signal amplitude in the equalizer 30 is excessive, a peak portion that is not less than a predetermined amplitude is cut by the equalizer 30. Therefore, if the peak detected by the peak detecting unit 201 is equal to an upper or lower limit of a passband in the equalizer 30, the peak portion of the signal is cut by the equalizer 30, so that there is a high possibility that an error rate may increase.

The peak detecting unit 202 detects a peak of the amplitude of a signal output from an A/D converter 40. In the A/D converter 40, the signal is amplified at the gain Ka, and quantization is subsequently performed. If a peak of the amplified signal is too small, a relative amplitude of noise for the peak is large, even if the noise is minute, so that A/D conversion error occurs. Therefore, when the peak detected by the peak detecting unit 202 is less than a predetermined threshold value, the reliability of quantization in the A/D converter 40 is low, and there is a high possibility that the error rate may increase.

The optimal gain determining unit 203 stores the peaks in a form associated with the gain Kp, the gain Ka, and the gain Kf that are set by the gain setting unit 102. After the optimal gain determining unit 203 stores peaks for all combinations of gains, the optimal gain determining unit 203 determines that a combination of gains in which the peak detected by the peak detecting unit 201 is less than the predetermined threshold value and the peak detected by the peak detecting unit 202 is not less than the predetermined threshold value is an optimal combination of gains. The optimal gain determining unit 203 instructs the gain setting unit 102 to respectively set the gain Kp, the gain Ka, and the gain Kf in the preamplifier 10, the A/D converter 40, and the FIR filter 50.

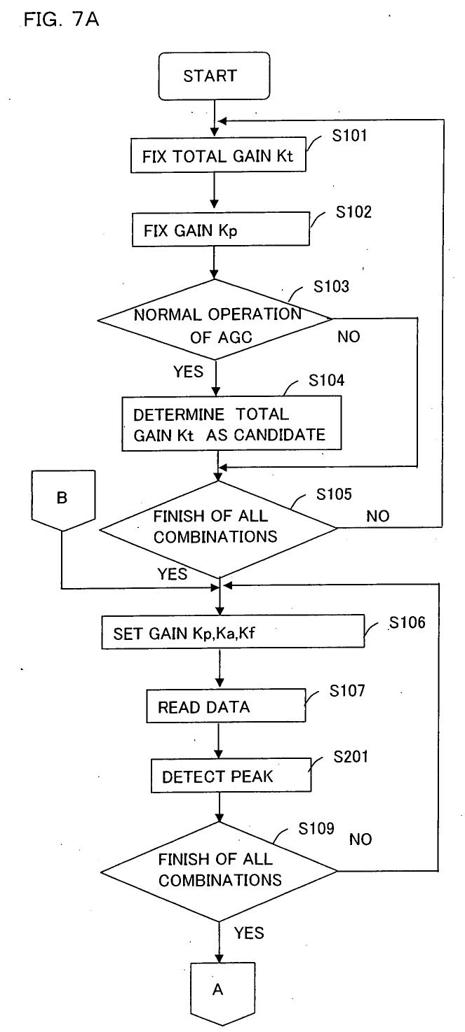

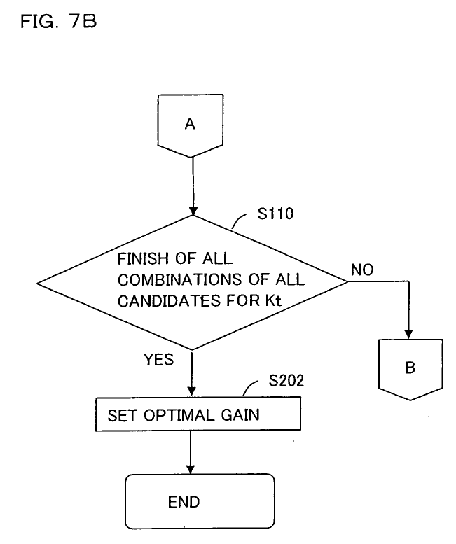

Next, a gain adjusting operation by the gain adjusting apparatus 100 having the above-described configuration is described below with reference to the flowchart shown in FIGS. 7A and 7B. In FIGS. 7A and 7B, portions identical to those shown in FIGS. 4A and 4B are denoted by identical reference numerals, and detailed descriptions thereof are omitted. Also in the second embodiment, the gain adjusting operation broadly includes determination of candidates for the total gain Kt and determination of the gain Kp, the gain Ka, and the gain Kf. The determination of candidates for the total gain Kt is similar to that in the first embodiment.

In step S101, the total gain candidate determining unit 101 fixes the total gain Kt of an AGC feedback loop including the equalizer 30, the A/D converter 40, and the FIR filter 50. In step S102, the total gain candidate determining unit 101 fixes the gain Kp of the preamplifier 10 to one of possible values of the gain Kp. In step S103, when the total gain Kt and the gain Kp are fixed, the total gain candidate determining unit 101 determines whether or not AGC by the variable gain amplifier 20 is possible.

If it is determined that the AGC is possible (Yes in step S103), in step S104, the total gain candidate determining unit 101 determines and stores the fixed total gain Kt as a candidate for actual use. Simultaneously, the total gain candidate determining unit 101 also stores the gain Kp of the preamplifier 10 that is fixed so as to correspond to the candidate for the total gain Kt. Alternatively, if the AGC is impossible (No in step S103), the fixed total gain Kt and the gain Kt are not stored by the total gain candidate determining unit 101.

In step S105, the total gain candidate determining unit 101 determines whether or not the above determination of whether the AGC is possible has finished for all combinations of possible values of the total gain Kt and the gain Kp. If the above determination of whether the AGC is possible has not finished yet (No in step S105), the total gain candidate determining unit 101 fixes the total gain Kt and the gain Kp for which the determination has not finished yet, and determines whether or not AGC is possible. If the above determination of whether the AGC is possible has finished for all the combinations (Yes in step S105), the process for determining the candidate for the total gain Kt is completed.

After completing the determination of the candidates for the total gain Kt, determination of the gain Kp, the gain Ka, and the gain Kf is performed. Specifically, one of the candidates for the total gain Kt stored in the total gain candidate determining unit 101 is selected, and the candidate for the total gain Kt and a corresponding gain Kp are reported to the gain setting unit 102. In step S106, the gain setting unit 102 determines the gain Ka of the A/D converter 40 and the gain Kf of the FIR filter 50 which satisfy the reported candidate for the total gain Kt, and respectively sets the gain Kp, the gain Ka, and the gain Kf in the preamplifier 10, the A/D converter 40, and the FIR filter 50. These gains are reported to the optimal gain determining unit 105.

After the gains are set, predetermined data is read from a recording medium (not shown) in step S107. In other words, a signal is read from the recording medium by a head (not shown), and is input as a reproduction signal to the preamplifier 10. The reproduction signal is preamplified at the gain Kp by the preamplifier 10 and is amplified at the gain Kv by the variable gain amplifier 20. The amplified signal is processed by each of the equalizer 30, the A/D converter 40, and the FIR filter 50. At this time, the gain Kv of the variable gain amplifier 20 is controlled by the AGC unit 60, whereby the amplitude of the reproduction signal is finally matched with the target amplitude. The combination of the total gain Kt and the gain Kp is determined in the range in which AGC is possible. Thus, it is ensured that the amplitude can be matched with the target amplitude within the variable range of the gain Kv of the variable gain amplifier 20.

In addition, in step S201, when signals are output from the equalizer 30 and the A/D converter 40, peaks of the amplitudes of the signals are detected by the peak detecting units 201 and 202. In other words, the peak detecting unit 201 detects the peak of the signal output from the equalizer 30, and the peak detecting unit 202 detects the peak of the signal output from the A/D converter 40. The detected peaks are reported to the optimal gain determining unit 203. The detected peaks are stored in the optimal gain determining unit 203, with the peaks associated with a combination of currently set gains.

In step S109, after the gain Ka and the gain Kf are set with a candidate for the total gain Kt as a condition of constraint, the gain setting unit 102 determines whether or not the setting has finished for all combinations of the gain Ka and the gain Kf which satisfy the candidates for the total gain Kt. If the determination indicates that there is a combination of the gain Ka and the gain Kf which satisfy the candidate for the total gain Kt other than the already set combinations of the gain Ka and the gain Kf (No in step S109), the gain setting unit 102 sets, in the A/D converter 40 and the FIR filter 50, the combination of gains that has not been set. Reading of data and detection of the peaks are performed again, and the optimal gain determining unit 203 stores two peaks corresponding to a new combination of gains.

If this processing is repeated and pairs of peaks corresponding to all the combinations of the gain Ka and the gain Kf which satisfy the candidate for the total gain Kt are stored (Yes in step S109), in step S110, the gain setting unit 102 determines whether or not the above processing has been performed for all the candidates for the total gain Kt. If this determination indicates that there is a candidate for the total gain Kt on which the above processing has not been performed yet (No in step S110), after a combination of the candidate for the total gain Kt and the gain Kp is altered, detection of peaks corresponding to the combination of the gain Ka and the gain Kf which satisfy the candidate for the total gain Kt is performed. If the peak detection has finished for all the combinations of the gain Ka and the gain Kf which satisfy all the candidates for total gain Kt (Yes in step S110), in the optimal gain determining unit 203, the peaks of the signals output from the equalizer 30 and the A/D converter 40 are stored, with the peaks associated with all the combinations of gains.

The optimal gain determining unit 203 determines that a combination of gains in which the peak detected by the peak detecting unit 201 is less than a predetermined threshold value and the peak detected by the peak detecting unit 202 is not less than a predetermined threshold value is an optimal combination of gains, and reports the optimal combination to the gain setting unit 102. The threshold values for comparison with the peaks are not equal but differ.

The peak detected by the peak detecting unit 201 is a peak of a signal obtained such that the equalizer 30 performs frequency characteristic adjustment and is a peak of a signal obtained such that the equalizer 30 performs filtering. Specifically, in the equalizer 30, as shown in FIGS. 8A and 8B, when a pass amplitude of the circuit exists, and a signal amplitude is excessive, an input amplitude and an output amplitude after filtering are limited (see FIG. 8A). Therefore, the peak of the signal output from the equalizer 30 is equal to an upper limit of the pass amplitude of the equalizer 30 at a maximum. When this peak is equal to the upper limit of the pass amplitude of the equalizer 30, there is a high possibility that a peak portion is cut by the equalizer 30, thus causing an increase in error rate. Therefore, an upper limit threshold value for comparison with the peak detected by the peak detecting unit 201 is a value equal to or less than the upper limit of the pass amplitude of the equalizer 30. When a peak equal to or greater than the threshold value is detected by the peak detecting unit 201, it is determined that the error rate increases.

Conversely, when the signal amplitude is too small, the magnitude of minute circuit noise is relatively large for the signal amplitude (see FIG. 8B), thus causing an increase in error rate. Therefore, a lower limit threshold value for comparison with the peak detected by the peak detecting unit 201 is determined by considering the influence of noise. When a peak that is less than this threshold value is detected by the peak detecting unit 201, it is determined that the error rate increases.

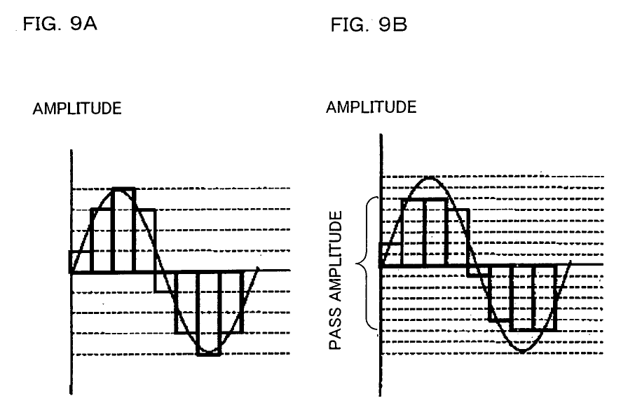

In addition, the peak detected by the peak detecting unit 202 is a peak of a signal obtained such that the A/D converter 40 performs amplification and quantization, and is a peak of a digital signal. In the A/D converter 40, as shown in FIGS. 9A and 9B, analog signal quantization is performed with a predetermined number of quantization bits and a quantization width. When the amplitude in the A/D converter 40 is small, quantization error increases (see FIG. 9A), thus causing an increase in error rate. Therefore, the lower limit threshold value for comparison with the peak detected by the peak detecting unit 202 is determined by considering the number of quantization bits and quantization width in the A/D converter 40. When a peak less than this threshold value is detected by the peak detecting unit 202, it is determined that the error rate increases.

Conversely, when the amplitude in the A/D converter 40 is large, the amplitude exceeds an amplitude range in which A/D conversion can be performed, and an excess portion cannot be quantized (see FIG. 9B), thus causing an increase in error rate. Therefore, the upper limit threshold value for comparison with the peak detected by the peak detecting unit 202 is a value that is equal to or less than an upper limit of an amplitude that can be quantized by A/D conversion. When a peak that is equal to or greater than this threshold value is detected by the peak detecting unit 202, it is determined that the error rate increases.

By comparing the threshold values with the peaks, as described above, an optimal combination of gains for suppressing the error rate to the minimum is determined. After the optimal combination is reported to the gain setting unit 102, in step S202, the gain setting unit 102 respectively sets optimal gains in the preamplifier 10, the A/D converter 40, and the FIR filter 50. When there are combinations of gains in which the peaks satisfy conditions of the threshold values, a combination of gains in which the peaks are more separated from the threshold values may be selected.

As described above, it is confirmed that the gains set in the preamplifier 10, the A/D converter 40, and the FIR filter 50 enable AGC within the variable range of the gain Kv of the variable gain amplifier 20 by determination of the candidate for the total gain Kt, and it is difficult for an error to occur, the error being caused by processing in the equalizer 30 and the A/D converter 40.

As described above, according to the second embodiment, the entirety of an AGC feedback loop is regarded as a virtual amplifier, and, among combinations of a total gain, which is a gain of the amplifier, and a preamplifier gain, a combination in which AGC by a variable gain amplifier 20 is possible is determined. By using, as a condition of constraint, a total gain of the determined combination, gains in processing units of the AGC feedback loop are set, and gains at which an amplitude suitable for equalizing and A/D conversion is obtained is selected. Accordingly, gains are selected for the A/D converter 40, the FIR filter 50, etc., in a feedback loop in which it is difficult for an error to occur at a total gain at which AGC is possible, so that the error rate can be suppressed to the minimum and AGC can operate normally. In addition, processing for directly calculating the error rate can be eliminated.

In each of the foregoing embodiments, a case in which a gain adjusting apparatus 100 is added to an AGC circuit has been described. However, by loading a program for executing the above-described processing into an apparatus including an AGC circuit, a processor, such as a central processing unit or microprocessor unit, can execute the program. In addition, the gain adjusting apparatus 100 may be built into an apparatus including an AGC circuit, and may be removably mounted in the apparatus.

The present invention can be applied to a case in which AGC is allowed to operate normally, while suppressing an error rate to the minimum.

What is claimed is:

1. A gain adjusting apparatus for adjusting gains in a feedback loop for performing automatic gain control of a variable gain amplifier, the gain adjusting apparatus comprising:
a first determining unit configured to determine a total gain in a plurality of processes in the feedback loop, said total gain matching an amplitude of an input signal to a predetermined target amplitude within a variable range of a gain of the variable gain amplifier;
a gain setting unit configured to sequentially set combinations of gains in the processes, the combinations equaling the total gain determined by the first determining unit; and
a second determining unit configured to an optimal combination of gains in accordance with a status of a signal amplified at the gains set by the gain setting unit.

2. The gain adjusting apparatus according to claim 1, wherein:
the second determining unit includes an error rate calculating unit that calculates an error rate of the signal amplified at the gains set by the gain setting unit; and
the second determining unit determines, as the optimal combination, a combination of gains for minimizing the error rate calculated by the error rate calculating unit.

3. The gain adjusting apparatus according to claim 2, wherein the error rate calculating unit calculates the error rate by comparing known data with amplified data in a signal obtained by amplifying a signal including the known data at the gains set by the gain setting unit.

4. The gain adjusting apparatus according to claim 1, wherein:
the second determining unit includes a peak detecting unit that detects an amplitude peak of a signal obtained by performing each process in which the gain is set by the gain setting unit; and
the second determining unit determines, as the optimal combination, a combination of gains in which the peak detected by the peak detection unit satisfies a predetermined condition.

5. The gain adjusting apparatus according to claim 4, wherein:
the peak detection unit detects, as the amplitude peak, an amplitude peak of a signal obtained by performing equalizing for adjusting signal frequency characteristics; and
the second determining unit determines, as the optimal combination, a combination of gains in which the amplitude peak detected by the peak detection unit is less than a predetermined threshold value.

6. The gain adjusting apparatus according to claim 4, wherein:
the peak detection unit detects, as the amplitude peak, an amplitude peak of a signal obtained by performing analog-to-digital conversion for converting an analog signal into a digital signal by performing quantization; and
the second determining unit determines, as the optimal combination, a combination of gains in which the amplitude peak detected by the peak detection unit is equal to or greater than a predetermined threshold value.

7. The gain adjusting apparatus according to claim 1, wherein:
the first determining unit determines a combination of gains in which the amplitude of the input signal can be matched with the predetermined target amplitude within the variable range of the gain of the variable gain amplifier, the combination of gains is within combinations of the total gain and a gain in a preamplification process for amplifying the input signal prior to the variable gain amplifier.

8. A storage apparatus for amplifying a reproduction signal of data stored in a storage medium by performing automatic gain control of a variable gain amplifier, the storage apparatus comprising:
a first determining unit configured to determine a total gain in a plurality of processes in an automatic-gain-control feedback loop, said total gain matching an amplitude of an input signal to a predetermined target amplitude within a variable range of a gain of the variable gain amplifier;
a gain setting unit configured to set sequentially combinations of gains in the processes, the combinations equaling the total gain determined by the first determining unit; and
a second determining unit configured to determine an optimal combination of gains in accordance with a status of a signal amplified at the gains set by the gain setting unit.

9. A gain adjusting method for adjusting gains in a feedback loop for performing automatic gain control of a variable gain amplifier, the gain adjusting method comprising the steps of:
(a) determining a total gain in a plurality of processes in the feedback loop, said total gain matching an amplitude of an input signal to a predetermined target amplitude within a variable range of a gain of the variable gain amplifier;
(b) setting sequentially combinations of gains in the processes, the combinations equaling the total gain determined in step (a); and
(c) determining an optimal combination of gains in accordance with a status of a signal amplified at the gains set in step (b).
